(19) United States
(12) Patent Application Publication
(10) Pub. No.: US 2010/0245289 A1
(43) Pub. Date: Sep. 30, 2010

(54) APPARATUS AND METHOD FOR OPTICAL PROXIMITY SENSING AND TOUCH INPUT CONTROL

(76) Inventor: Miroslav Svajda, Sunnyvale, CA (US)

Correspondence Address: HOWISON & ARNOTT, L.L.P, P.O. BOX 741715, DALLAS, TX, 75374-1715, US

(21) Appl. No.: 12/415,199

(22) Filed: Mar. 31, 2009

(51) Int. Cl. G06F 3/042

(52) U.S. Cl. 345/175

(57) ABSTRACT

Systems, circuits and methods are shown for optical proximity sensing and touch input control involving mounting light sources and an optical receiver with a touch input device, activating a first light source and measuring a first reflected light signal from an object using the receiver to obtain a first measured reflectance value, activating a second light source and measuring a second reflected light signal from the object using the receiver to obtain a second measured reflectance value, determining an approximate position of the object based on the first and second measured reflectance values, determining whether the position of the object is within a predetermined proximity area to the touch input device, and activating the touch input device if the object is within the predetermined proximity area or selectively activating or scanning part of the touch input device based on the position of the object.

### CROSS-REFERENCE TO RELATED PATENT APPLICATIONS

This patent application is related to co-pending U.S. patent application Ser. No. 12/334,296, filed Dec. 12, 2008, herein incorporated by reference in its entirety for all purposes.

### FIELD OF THE INVENTION

This invention pertains to optical proximity detection and, more particularly, control of a touch screen input using optical proximity detection.

### BACKGROUND OF THE INVENTION

Conventional systems exist that perform control of touch input devices, such as touch screens. Typically, touch screen based systems collect user inputs using a touch screen that monitors changes in capacitance on the touch screen to identify the position of user input from a stylus or finger in contact with the touch screen. Changes in the capacitance in the touch screen device are monitored and interpreted to determine the user's input.

### BRIEF SUMMARY OF THE INVENTION

In one embodiment, a touch input and optical proximity sensing system is shown having first and second light sources and a first optical receiver configured to receive a first reflected light signal from an object when the first light source is activated and output a first measured reflectance value corresponding to an amplitude of the first reflected light signal and receive a second reflected light signal from the object when the second light source is activated and output a second measured reflectance value corresponding to an amplitude of the second reflected light signal. The system includes a first touch input device, where the first and second light sources and the first optical receiver are in predetermined positions relative to the first touch input device. A controller is in communication and control of the first and second light sources, the first optical receiver and the first touch input device. The controller is configured to independently activate the first and second light sources to produce the first and second reflected light signals and capture the first and second measured reflectance values from the first optical receiver. The controller is further configured to determine a first approximate position of the object based on the first and second measured reflectance values and determine whether the first approximate position of the object is within a predetermined proximity area to the first touch input device and, if the object is within the predetermined proximity area, the controller is configured to activate at least a portion of the first touch input device.

In a further refinement of this embodiment, the first optical receiver is configured to receive a third reflected light signal from an object when the first light source is activated and output a third measured reflectance value corresponding to an amplitude of the third reflected light signal and receive a fourth reflected light signal from the object when the second light source is activated and output a fourth measured reflectance value corresponding to an amplitude of the fourth reflected light signal. The controller is further configured to independently activate the first and second light sources to produce the third and fourth reflected light signals and capture the third and fourth measured reflectance values from the first optical receiver, and the controller is further configured to determine a second approximate position of the object based on the third and fourth measured reflectance values and compare the first and second approximate positions in order determine whether the object is approaching the first touch input device and, activate the portion of the first touch input device when the object is approaching the first touch input device.

In another refinement of this embodiment, the system includes a third light source and the first optical receiver is configured to receive a fifth reflected light signal from the object when the third light source is activated and output a fifth measured reflectance value corresponding to an amplitude of the fifth reflected light signal. The controller is in communication and control of the third light source and is configured to independently activate the third light source to produce the fifth reflected light signal and capture the fifth measured reflectance value from the first optical receiver. The controller is further configured to determine the first approximate position of the object based on the first, second and fifth measured reflectance values and selectively activate the portion of the first touch input device based on the first approximate position derived from the first, second and fifth measured reflectance values.

In a different refinement of this embodiment, the system includes a second touch input device and the controller is in communication and control of the second touch input device, where the controller is configured to selectively activate at least one of the first and second touch input devices based on the first approximate position of the object. In still another refinement, the controller is configured to activate the portion of the first touch input device by scanning the portion of the first touch input device.

An embodiment of a method for optical proximity sensing and touch input control calls for mounting a plurality of light sources and a first optical receiver in predetermined position relative to a first touch input device. The method involves activating at least a first one of the light sources and measuring an amplitude of a first reflected light signal from an object using the first optical receiver to obtain a first measured reflectance value, activating at least a second one of the light sources and measuring an amplitude of a second reflected light signal from the object using the first optical receiver to obtain a second measured reflectance value, and determining a first approximate position of the object based on the first and second measured reflectance values. The method also involves determining whether the first approximate position of the object is within a predetermined proximity area to the first touch input device and activating at least a portion of the first touch input device if the object is within the predetermined proximity area.

In a refinement of this embodiment of a method, the method includes the steps of activating the first one of the light sources and measuring an amplitude of a third reflected light signal from the object using the first optical receiver to obtain a third measured reflectance value, activating the second one of the light sources and measuring an amplitude of a fourth reflected light signal from the object using the first optical receiver to obtain a fourth measured reflectance value, determining a second approximate position of the object based on the third and fourth measured reflectance values, and comparing the first and second approximate positions in order determine whether the object is approaching the first touch input device. In this refinement, the step of activating at least a portion of the first touch input device further includes activating the portion of the first touch input device when the object is approaching the first touch input device.

In another refinement of the embodiment of a method, the method includes the steps of activating a third one of the light sources and measuring an amplitude of a fifth reflected light signal from the object using the first optical receiver to obtain a fifth measured reflectance value. In this refinement, the step of determining a first approximate position of the object further comprises determining the first approximate position of the object based on the first, second and fifth measured reflectance values and the step of selectively activating the portion of the first touch input device based on the first approximate position further includes selectively activating the portion of the first touch input device based on the first approximate position derived from the first, second and fifth measured reflectance values.

In still another refinement of the method, the method includes mounting a second touch input device in predetermined position relative to the plurality of light sources and the first optical receiver and the step of determining whether the first approximate position of the object is within a predetermined proximity area to the first touch input device further includes determining whether the first approximate position of the object is within another predetermined proximity area to the second touch input device. In this refinement, the method includes the step of activating at least a portion of the second touch input device if the object is within the another predetermined proximity area.

In another refinement of the method, the step of activating at least a portion of the first touch input device further comprises scanning the portion of the first touch input device.

In yet another refinement of the method, the method includes mounting a second optical receiver in a predetermined position with respect to the first and second light sources and the first touch input device, where the second optical receiver is configured to receive reflected light signals from the object when at least one of the first and second light sources is activated and output a first measured reflectance value corresponding to an amplitude of the received reflected light signals and the step of determining the first approximate position of the object further comprises determining the first approximate position of the object based on the first and second measured reflectance values and the measured reflectance values from the second optical receiver in order to determine whether the first approximate position of the object is within the predetermined proximity area to the first touch input device.

### BRIEF DESCRIPTION OF THE DRAWINGS

Certain exemplary embodiments of the present invention are discussed below with reference to the following figures, wherein:

FIG. 1 is a cross-sectional sideview diagram of an embodiment of a touch screen and optical proximity sensing system in accordance with the present invention based on two light emitting diodes and an optical receiver;

FIGS. 2-4 are simplified sideview diagrams illustrating a series of reflectance measurements performed using the optical proximity sensing of the system of FIG. 1 involving an object in a series of different positions relative to the system;

FIG. 5 is a perspective diagram of an embodiment of a touch screen and optical proximity sensing system in accordance with the present invention based on four light emitting diodes and an optical receiver;

FIG. 6 is a sideview diagram of an embodiment of a touch screen and optical proximity sensing system in accordance with the present invention based on one light emitting diode and two optical receivers;

FIG. 7 is a perspective diagram of an embodiment of a touch screen and optical proximity sensing system in accordance with the present invention based on one light emitting diode and four optical receivers;

FIG. 8 is a perspective diagram of an embodiment of a touch screen and optical proximity sensing system in accordance with the present invention based on three light emitting diodes and an optical receiver;

FIG. 9 is a perspective diagram of an embodiment of a touch screen and optical proximity sensing system in accordance with the present invention based on one light emitting diode and three optical receivers;

FIG. 10 is a functional block diagram of one example of a touch screen and optical proximity sensing system suitable for use in accordance with the present invention based on three light emitting diodes and an optical receiver;

FIG. 11 is a circuit diagram illustrating one example of circuitry for optical reception for a portion of the touch screen and optical proximity sensing system of FIG. 10;

FIG. 12 is a control flow diagram illustrating one example of a process in the controller of FIG. 10 that performs motion detection and touch screen activation suitable for use with the touch screen and optical proximity sensing systems shown in FIGS. 1-9;

FIG. 13 is a top view of an example of a user input system featuring a touch screen and optical proximity sensing system having multiple proximity sensors and a touch screen that may be selectively activated or scanned;

FIG. 14 is a functional block diagram of one example of a touch screen and optical proximity sensing system suitable for use with the user input system of FIG. 13;

FIG. 15 is a cross-sectional sideview of a portion of a touch screen and optical proximity sensing system having a opaque layer over the touch screen with optically transparent windows for optical proximity sensing;

FIG. 16 is a simplified top view of the touch screen and optical proximity sensing system of FIG. 13, where a portion of the touch screen area is selectively activated or scanned;

FIG. 17 is a functional block diagram of another example of a touch screen and optical proximity sensing system where multiple proximity sensors are associated with multiple capacitive touch screen arrays;

FIG. 18 is a control flow diagram illustrating one example of a process in the controller of FIG. 10 that performs motion detection, selective touch screen activation or scanning, and gesture recognition based on approximating changes in position using reflectance measurements suitable for use with the touch screen and optical proximity sensing system shown in FIGS. 13 and 14; and

FIG. 19 is a topview diagram illustrating an example of a user input system that features multiple touch screen inputs having differing characteristics suitable for use with the architecture of FIG. 17 and the control process of FIG. 18.

### DETAILED DESCRIPTION OF THE INVENTION

Described below are several exemplary embodiments of systems and methods for touch screen control and optical proximity sensing that may include motion detection or gesture recognition based on approximate position determinations using relatively simple optical receivers, such as proximity sensors or infrared data transceivers, to perform reflectance measurements. Motion detection may be used to activate a touch input device, such as a capacitive touch screen, that may be deactivated to save power when no motion activity is detected. Alternatively, motion detection and position sensing may be used to selectively activate or scan a portion of a touch input device to save power or reduce spurious input. In still another alternative, gesture recognition based on the sensed motion is combined with touch input to interpret user input.

In general terms, motion detection or gesture recognition is based on repeatedly measuring reflectance from an object to determine approximate position for the object, comparing the measured reflectances to identify changes in the approximate position of the object over time, and interpreting the change in approximate position of the object as motion correlating to a particular gesture, which may be interpreted as a user movement or as a motion vector of the object.

The positions are generally rough approximations because the reflectance measurements are highly dependent upon the reflectance of the object surface as well as orientation of object surface. Use of the reflectance measurement values from simple optical systems to obtain an absolute measure of distance is typically not highly accurate. Even a system that is calibrated to a particular object will encounter changes in ambient light and objection orientation, e.g. where the object has facets or other characteristics that affect reflectance independent of distance, that degrade the accuracy of a distance measurement based on measured reflectance.

Because of the variations in reflectance, distance measurements are not reliable, but relative motion can be usefully measured. The present systems and methods for gesture recognition, therefore, rely on relative changes in position. Though the measure of relative motion assumes that the variations in the reflectance of the object are due to motion and not the other factors, such as orientation. Using a single reflectance measurement repeated over time, e.g. a system based on a single LED and receiver, motion of an object toward or away from the system can be identified on a Z axis. This may be useful for a simple implementation, such as a light switch or door opener, or, in machine vision and control applications, the approach of the end of a robot arm to an object, for example. Using two reflectance measurements, e.g. two LEDs and a receiver or two receivers and an LED, reasonable accuracy for position along an X axis may be obtained along with some relative sense of motion in the Z axis. This may be useful for a relatively simple touchless mobile phone interface or slider light dimmer or, in machine vision and control applications, movement of an object along a conveyor belt, for example. Using three or more reflectance measurements, e.g. three LEDs and a receiver or three receivers and an LED, the system can obtain reasonable accuracy for position along X and Y axes, and relative motion in the Z axis. This may be useful for more complex applications, such as a touchless interface for a personal digital assistant device or vision based control of automated equipment. A high number of reflectance measurements can be realized by using multiple receivers and/or LEDs to increase resolution for improved gesture recognition.

In one preferred embodiment, for reflectance measurements, multiple light sourced, such as LEDs, are activated and the resulting photodiode current is measured. In this embodiment, each LED is selectively activated and the receiver measures the resulting photodiode current for each LED when activated. The photodiode current is converted to a digital value and stored by a controller, such as a microprocessor. The measurements are repeated under the control of the processor at time intervals, fixed or variable. The measurements at each time are compared to obtain an approximate determination of position in X and Y axes. The measurements between time intervals are compared by the processor to determine relative motion, i.e. vector motion, of the object.

The relative position of an object in motion can be detected. The detection of the motion in proximity to a touch input device may be used to activate the touch input, which otherwise may remain inactive to conserve power. Alternatively, the relative position of the object in motion can be utilized to selectively activate or scan a portion of the touch input device or to control the scan rate in a portion of the touch input device relative to other portions of the touch input device. In still another alternative, the relative position of the object in motion can be utilized to selectively activate or scan a subset of multiple touch input devices to collect user input information.

In yet another example, the motion of the object may be interpreted or recognized as a gesture and the gesture combined with the touch input information to interpret user input. The relative motion of the object can be interpreted as gestures. For example, positive motion primarily in the X axis can be interpreted as right scroll and negative motion as a left scroll. Positive motion in the Y axis is a down scroll and negative motion is an up scroll. Positive motion in the Z axis can be interpreted as a selection or click (or a sequence of two positive motions as a double click. Relative X and Y axis motion can be used to move a cursor. The gesture may also be a motion vector for the object or for the receiver system mounted on a piece of equipment, e.g. a robot arm. For example, in automated equipment applications, motion of an object along an axis may be tracked to detect an object moving along a conveyor belt. By way of another example, the motion vector may be tracked to confirm proper motion of a robot arm or computer numerically controlled (CNC) machinery components with respect to workpiece objects or to detect unexpected objects in the path of the machinery, e.g. worker's limbs or a build up of waste material.

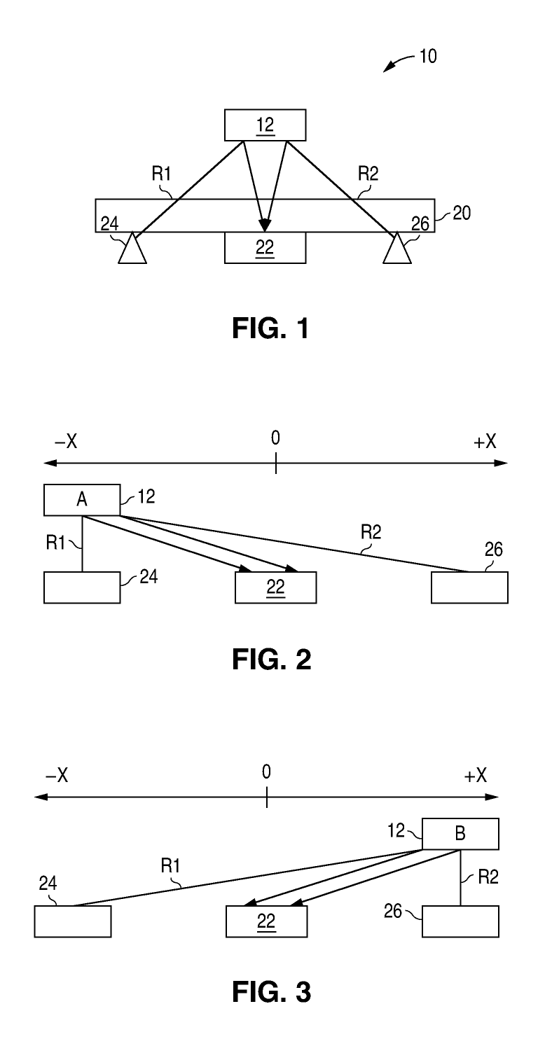

FIG. 1 is a cross-sectional sideview diagram of an embodiment of a touch input and optical proximity sensing system 10 in accordance with the present invention based on two light emitting diodes 24, 26 and an optical receiver 22.

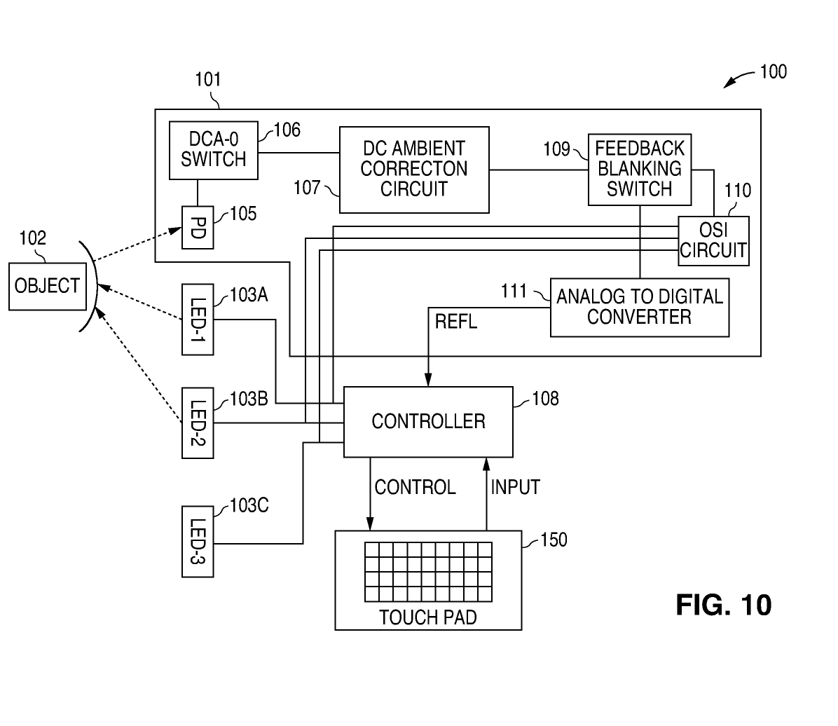

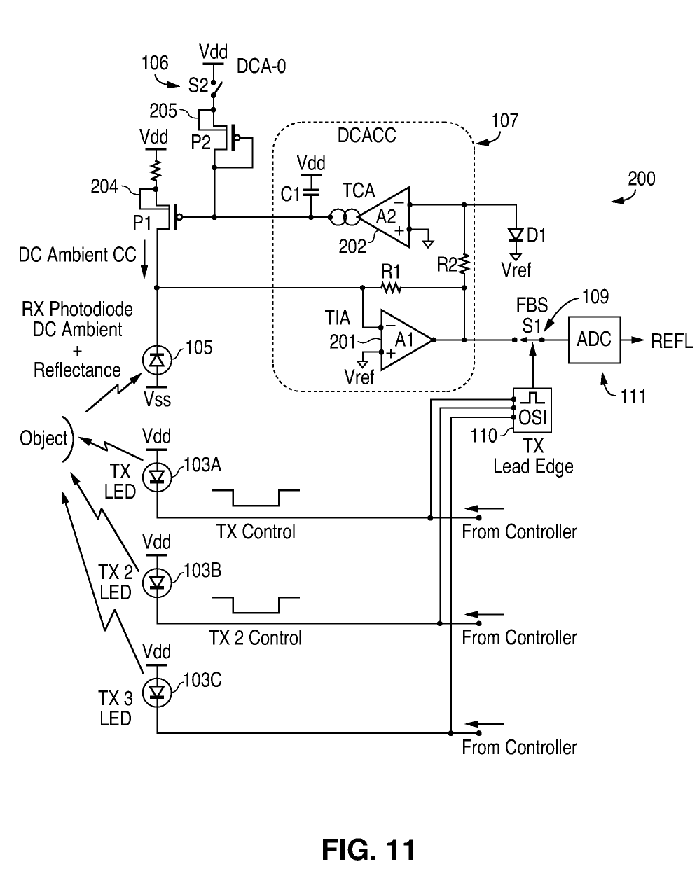

In this embodiment, receiver 22 and LEDs 24, 26 are mounted along an axis, e.g. an X axis, below a touch input device 20, such as a capacitive touch screen. LEDs 24 and 26 are independently activated and a photodiode in receiver 22 detects reflected light R1 and R2, respectively, from a target object 12. The strength of the reflected light signals R1 and R2 are measured by optical receiver 22. It is assumed that the strength of the reflected light signal roughly represents the distance of object 12 from the system 10. FIGS. 10 and 11 discussed below show examples of optical circuits that may be adapted for use as the receiver 22 and LEDs 24, 26 shown in FIG. 1.

The touch input and optical proximity sensing system 10 of FIG. 1 is configured to determine a position of object 12 along an X axis defined by the receiver 22 and LEDs 24, 26. The position of object 12 is made on the basis of the relative strength of the reflected light R1 and R2 measure from each of the LEDs 24 and 26. FIGS. 2-4 are sideview diagrams illustrating a series of reflectance measurements for R1 and R2 performed using the optical system of FIG. 1 involving object 12 in a series of different positions relative to the optical system along an X axis. The reflectance measurements may be utilized to sense the proximity of object 12, the relative position of object 12, and/or the relative motion of object 12.

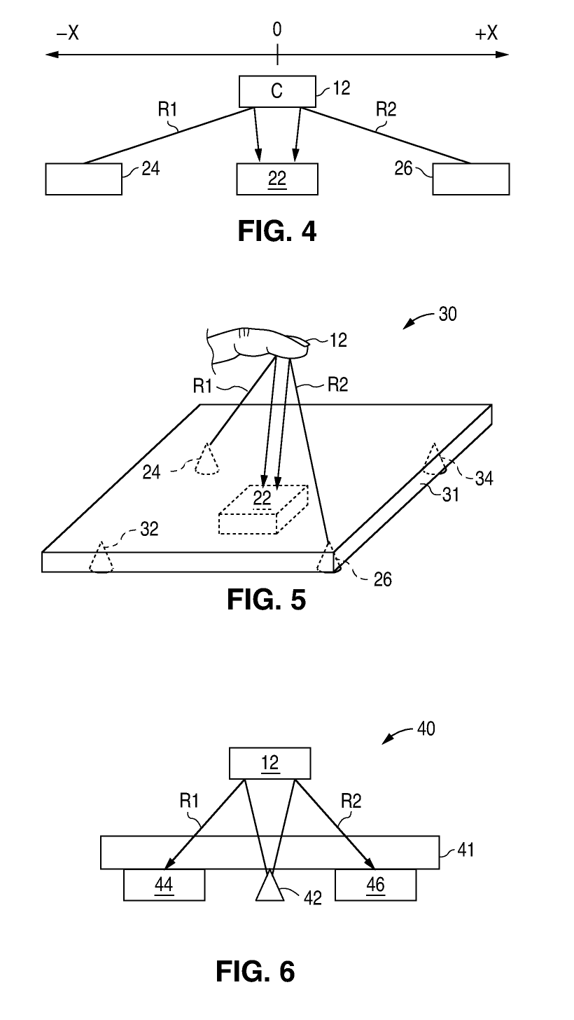

In the example of FIG. 2, object 12 is located near LED 24 and, consequently, the reflected light R1 from LED 24 measured by receiver 22 is much greater in amplitude than the reflected light R2 from LED 26. Based on the relative amplitudes measured for R1 and R2, the controller in receiver 22 determines that object 12 is located at −X along the X axis. In the example of FIG. 3, object 12 is located near LED 26 and, consequently, the reflected light R2 from LED 26 measured by receiver 22 is much greater in amplitude than the reflected light R1 from LED 24. Based on the relative amplitudes measured for R1 and R2, the controller in receiver 22 determines that object 12 is located at +X along the X axis. In FIG. 4, object 12 is located near receiver 22 and, consequently, the reflected light R1 from LED 24 measured by receiver 22 is substantially the same as the reflected light R2 from LED 26. Based on the roughly equivalent amplitudes measures for R1 and R2, the controller in receiver 22 determines that object 12 is located at 0 along the X axis. Thus, the relative position of object 12 along the X axis may be determined and utilized, as discussed below, for activation of the touch input device 20 or a portion thereof.

In addition, as demonstrating using FIGS. 2-4, if receiver 22 records a series of position measurements of −X, 0, and +X sequentially in time for object 12, then the controller in receiver 22 may recognize the left to right motion of object 12 as a gesture. For example, in an application involving a mobile phone or PDA device, this gesture may be recognized as a scroll right command for controlling the data shown on a display for the device. Similarly, a right to left motion, e.g. a sequence of position determinations of +X, 0, and −X, may be recognized as a scroll left command. The magnitude of the scroll may be correlated to the magnitude of the change in position. For example, a gesture defined by a sequence of position measurements by receiver 22 of +X/2, 0, and −X/2, may be interpreted as a left scroll of half the magnitude as the gesture defined by the sequence +X, 0, and −X. The gesture recognition may be utilized to confirm the touch input to reduce spurious inputs, e.g. if the touch input is consistent with the optically sensed motion. Alternatively, the gesture recognition may be used to enhance the touch input information. These values and examples are for illustration and one of ordinary skill in the art will recognize that sophisticated probabilistic or non-linear algorithms for interpreting the gesture from the position measurements may be applied to this example without departing from the scope of the invention.

Also note that the distance of object 12 from receiver 22 may also be determined on a relative basis. For example, if the ratio of R1 to R2 remains substantially the same over a sequence of measurements, but the absolute values measured for R1 and R2 increase or decrease, this may represent motion of object 12 towards receiver 22 or away from receiver 22, respectively. This motion of object 12 may, for example, be interpreted as a gesture selecting or activating a graphical object on a display, e.g. clicking or double clicking.

The principles for two dimensional optical proximity detection, object position determination and gesture recognition described above with respect to FIGS. 1-4 may be extended to three dimensional applications. FIG. 5 is a perspective diagram of an embodiment of a touch input and optical proximity sensing system 30 in accordance with the present invention based on optical receiver 22 and four light emitting diodes 25, 26, 32, 34. In this embodiment, receiver 22 and LEDs 24 and 26 are arranged along an X axis, as described above. A Y axis is defined by the alignment of receiver 22 and LEDs 32 and 34. Receiver 22 and LEDs 24, 26, 32, 34 are mounted below a touch input device 31, such as a capacitive touch screen. The relative position of object 12 along the Y axis may be determined using receiver 22 and LEDs 32 and 34 in a manner similar to that described above with regard to the X axis and LEDs 24 and 26. LEDs 32 and 34 are activated independently of one another and of LEDs 24 and 26 and receiver 22 measures the resulting reflection from object 12. By way of example, determining the position of object 12, e.g. a user's finger or a workpiece, in both the X and Y axes, a portion of touch input device 31 proximate to the object may be selectively activated or scanned or one of several touch input devices may be selectively activated.

Motions involving changes in distance from receiver 22 can also be identified by monitoring changes in amplitude of the measurements from LEDs 24, 26, 32, 34 when the relative ratios of the measured reflections follow the same relationship, i.e. the relation of reflectance to distance is not linear, but tends to be the same or similar for each LED and receiver in the system. To measure distance from the receiver, all LEDs can be activated simultaneously and the resulting measured reflectance will be proportional to a sum of all the individual reflectance contributions. This simple method may be used, for example, to detect if the object is in the proximity of a touch input device 31 in order to activate device 31 or initiate a gesture recognition algorithm.

The present invention may be implemented using multiple receivers and/or light sources. FIG. 7 is a sideview diagram of an embodiment of a touch input and optical proximity sensing system 40 in accordance with the present invention based on one light emitting diode 42 and two optical receivers 44 and 46 mounted below a touch input device 41. In this embodiment, LED 42 is activated and optical receivers 44 and 46 independently measure the reflection R1 and R2, respectively, from object 12. Relative position, distance and movement may be determined in a manner similar to that described above with respect to FIGS. 1-4. The ratios of R1 and R2 may be utilized to approximately determine the position of object 12 along an X axis on which are arranged LED 42 and optical receivers 44 and 46. A stronger measured reflectance for R1 than for R2 generally indicates proximity of object 12 to receiver 44. Likewise, a stronger measured reflectance for R2 than for R1 generally indicates proximity of object 12 to receiver 46. Substantially equivalent measured reflectances R1 and R2 generally indicates proximity of object 12 to LED 42. Substantially constant ratios of R1 and R2 with increasing or decreasing magnitudes for R1 and R2 generally indicates object 12 having moved closer or farther from LED 42. Proximity and position information may be utilized to activate or scan touch input device 41 or a selected portion of device 41, for example.

The principles for two dimensional object position determination and gesture recognition described above with respect to FIG. 6 may be extended to three dimensional applications. FIG. 7 is a perspective diagram of an embodiment of a touch input and optical proximity sensing system 50 in accordance with the present invention based on one light emitting diode 42 and four optical receivers 44, 46, 52, 54 mounted on or below a touch input device 51. Similar to the arrangement of FIG. 5, LED 42 and receivers 44 and 46 are arranged along an X axis while LED 42 and receiver 52 and 54 are arranged along a Y axis. Position of object 12 with respect to the X and Y axes of touch input and optical proximity sensing system 50 is obtained by measuring reflectance of light from LED 42 to each of the receivers 44, 46, 52, 54 in a manner similar to that described with respect to the arrangement of FIG. 5.

In the embodiments of FIGS. 6 and 7, LED 42 may be activated and each of the optical receivers may simultaneously measure reflectance. The reflectance measurements are transferred to a processor for calculation of position and gesture recognition. This may be accomplished in a variety of ways. For example, the optical receivers may be interfaced with a processor that performs gesture recognition. In another example, the optical receivers are networked and a processor within one of the receivers is utilized to perform optical proximity, position, or gesture recognition.

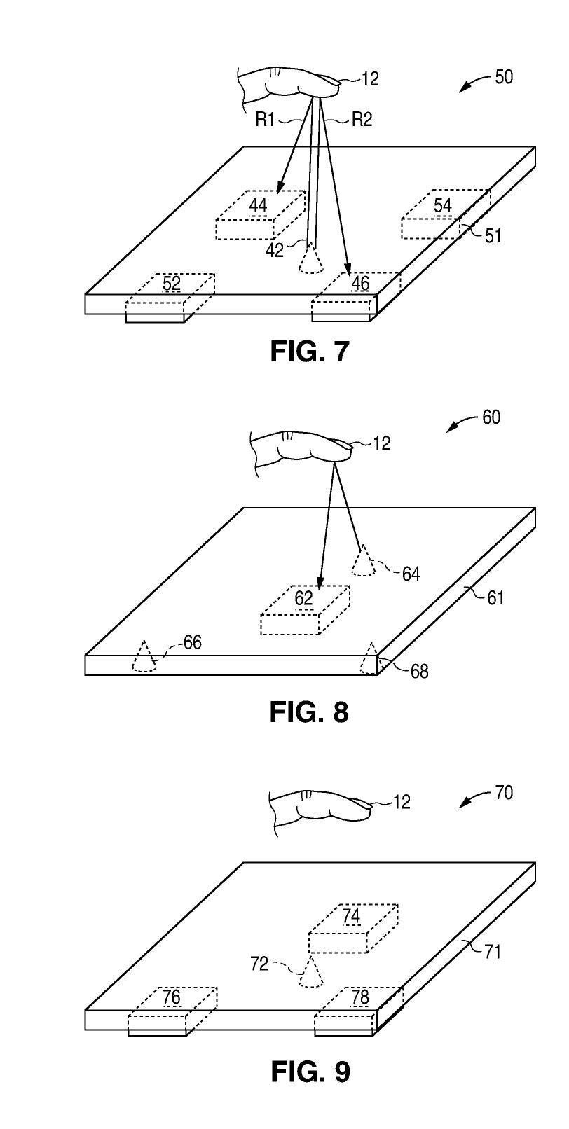

The number of elements used for reflectance measurement and gesture recognition may be varied as desired for a given application. The manner for determining the relative position of an object and the algorithm employed for gesture recognition need merely be adapted for the number and position of the elements. For example, FIG. 8 is a perspective diagram of an embodiment of a touch input and optical proximity sensing system 60 in accordance with the present invention based on one optical receiver 62 and three light emitting diodes 64, 66, 68 mounted on or below a touch input device 61. Similarly, FIG. 9 is a perspective diagram of an embodiment of a touch input and optical proximity sensing system 70 in accordance with the present invention based on one light emitting diode 72 and three optical receivers 74, 76, 78 mounted on or below a touch input device 71. Each of the embodiments of FIGS. 8 and 9 can detect the proximity and measure an approximate position of object 12 as well as detect three dimensional movement of object 12, which may be interpreted as a gesture. The calculations for position based on reflectance and gesture recognition are merely adapted for the position of LEDs 65, 66, 68 relative to receiver 62 in the embodiment of FIG. 8 and, similarly, adapted for the position of receiver 74, 76, 78 relative to LED 72 in the embodiment of FIG. 9.

FIG. 10 is a functional block diagram of one example of a sensor circuit architecture 100 for a touch input and optical proximity sensing system suitable for use in accordance with the present invention based on three light emitting diodes and an optical receiver. Optical systems that are suitable for use in the present invention generally provide a measure of reflectance that indicates an amplitude of the received optical signal. Sensor circuit 100 includes circuitry that is configured as an “active” optical reflectance proximity sensor (OPRS) device that can sense proximity by measuring a reflectance signal received at a photodiode (PD) 105 from an object 102 residing in or moving through the detection corridor or calibrated detection space of the module. Very basically, sensor circuit 100 works by emitting light through multiple light sources, such as light emitting diodes (LEDs) 103A-C, as implemented in this example. The light emitted from LEDs 103A-C, in this example, is directed generally toward an area, such as the region around touch pad 150, where object 102 may cause detection by its introduction into and/or movement through the object detection corridor or “visible” area of the sensor, which preferably corresponds to the location of touch input device 150. Reflected light from object 102 and ambient light from background or other noise sources is received at PD 105 provided as part of the sensor circuit and adapted for the purpose. Sensor circuit 100 is enhanced with circuitry 101 to reliably determine the amount of reflectance received from object 102 over noise and other ambient signals to a high degree of sensitivity and reliability.

There may be two or more LEDs such as LEDs 103A-C installed in sensor circuit 100 without departing from the spirit and scope of the present invention. Three LEDs are shown for the purpose of explaining the invention. In other embodiments there may be more than three LEDs chained in parallel, multiplexed, or independently wired and there may be multiple photodetectors 105 and associated optical receiver circuitry 101 and multiple touch input devices 150. Alternatively, other architectures will be suitable for use for touch input and optical proximity sensing and control, such as multiple sensor circuits 100 chained together, or multiple optical receiving circuitry 101 may be interfaced to a common controller 108. LEDs 103A-C in this example may be compact devices capable of emitting continuous light (always on) or they may be configured to emit light under modulation control. Likewise, they may be powered off during a sleep mode between proximity measurement cycles. The actual light emitted from the LEDs may be visible or not visible to the human eye such as red light and/or infrared light. In one embodiment, visible-light LEDs may be provided for optical reflectance measuring.

In this logical block diagram, the exact placement of components and the trace connections between components of sensor system 100 are meant to be logical only and do not reflect any specific designed trace configuration. FIGS. 1-9 show embodiments illustrating examples of possible placement of LEDs and optical receivers, though these examples are not exhaustive and do not limit the scope of the invention. In a preferred embodiment, LEDs 103A-C are located in proximity to touch pad 150 and PD 105 so that light (illustrated by broken directional arrows) reflects off of object 102 and is efficiently received by PD 105 as reflectance.

Optical receiver circuitry 101 includes a DC ambient correction circuit 107, which may be referred to hereinafter as DCACC 107. DCACC 107 is a first order, wide loop correction circuit that has connection to a DC ambient zero (DCA-0) switch 106 that is connected inline to PD 105 through a gate such as a PMOS gate described below. Optical receiver circuitry 101 may therefore be first calibrated where the DC ambient light coming from any sources other than optical reflectance is measured and then cancelled to determine the presence of any reflectance signal that may qualified against a pre-set threshold value that may, in one example, be determined during calibration of optical receiver circuitry 101.

Reflectance is determined, in one embodiment of the present invention, by measuring the amplified pulse width of an output voltage signal. Correction for DC ambient light is accomplished by providing optical receiver circuitry 101 with the capability of producing an amplified pulse width that is proportional to the measured DC ambient light entering PD 105. DCACC 107 and switch 106 are provided and adapted for that purpose along with a voltage output comparator circuit 111. More particularly, during calibration for DC ambient light, correction is accomplished by setting the DC-ambient correction to zero using switch 106 at the beginning of the calibration cycle and then measuring the width of the detected pulse during the calibration cycle. The width of the output pulse is proportional to the background DC ambient. Of course, during calibration, the transmitter LEDs 103A-C are disabled.

Sensor circuit 100, in this example, includes a power source and a controller 108. Controller 108 may be integrated on a circuit with optical receiver circuitry 101 or may be a separate device, such as a microprocessor mounted on a printed circuit board on chip carrier or may be a host processor. Controller 108 may be part of an interfacing piece of equipment or another optical receiver depending on the application. The power source for sensor circuit 100 may be a battery power source, a re-chargeable source or some other current source. In this example, the transmitter LEDs 103A-C are connected to and are controlled by controller 108 and may receive power through controller 108 as well. Optical receiver circuit 101 also has a connection to the power source for sensor circuit 100. More than one power source may be used to operate different parts of sensor circuit 100 without departing from the spirit and scope of the present invention. Controller 108, optical receiver circuitry 101, and touch pad device 150 are illustrated logically in this example to show that a processing device may be used to control the optical proximity sensor and touch input functions.

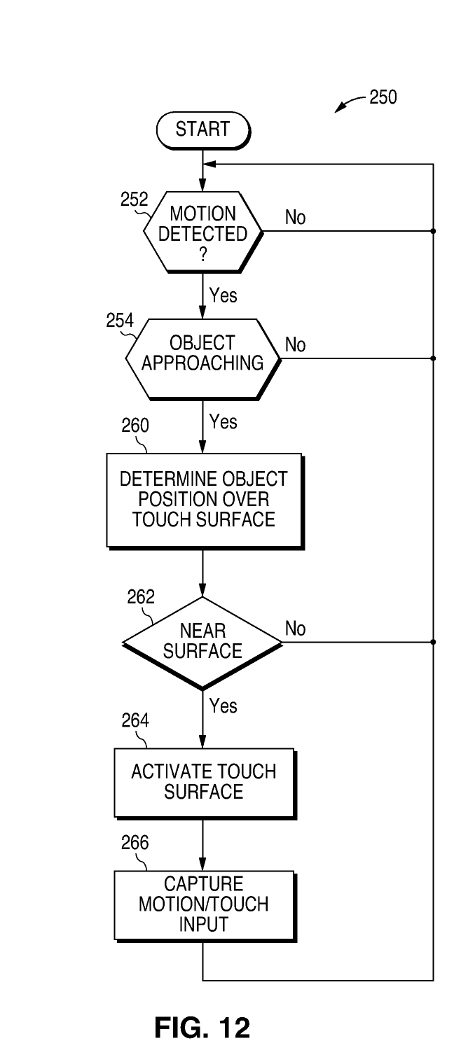

DC ambient circuit 107 produces a voltage from the input signal received from photodiode 105. Optical receiver circuitry 101 includes an analog to digital converter circuit (ADC) 111 that, in this example, converts an input voltage signal produced by photodiode 105 to a digital reflectance measurement value REFL that is output to controller 108. In this example, controller 108 is configured to make the motion and position detection steps of the process 250 of FIG. 12, as well as the activation and input capture functions. Input to ADC 111 from circuit 107 is routed through a feedback-blanking switch (FBS) 109 provided inline between DCACC 107 and ADC 111. In this embodiment, FBS 109 is driven by a one-shot circuit (OSI) 110, which provides the blanking pulse to the switch when LEDs 103A-C are enabled and transmitting under the control of controller 108. FBS 109 and OSI 110 in combination provide an additional sensitivity enhancement by reducing noise in the circuit.

In the operation of optical sensor circuit 100, calibration is first performed to measure the average DC ambient light conditions using DCACC 107 and ADC 111 with LEDs 103A-C switched off. When the DC ambient loop has settled and a valid threshold has been determined, LEDs 103A-C are independently switched on, in this example, by controller 108 for reflectance measurement. Reflectance received at PD 105 from object 102, in this example, produces a voltage above DC ambient. The resulting input voltage from PD 105 reaches ADC 111, which converts the voltage to a digital value REFL that is output to controller 108. Controller 108 activates one LED at a time and measures the resulting reflectance value REFL produced for each LED 103A-C. Controller 108 may then calculate an approximate position for object 102 based on the measured reflectance values and the relative positions of LEDs 103A-C and photodiode 105 with respect to one another.

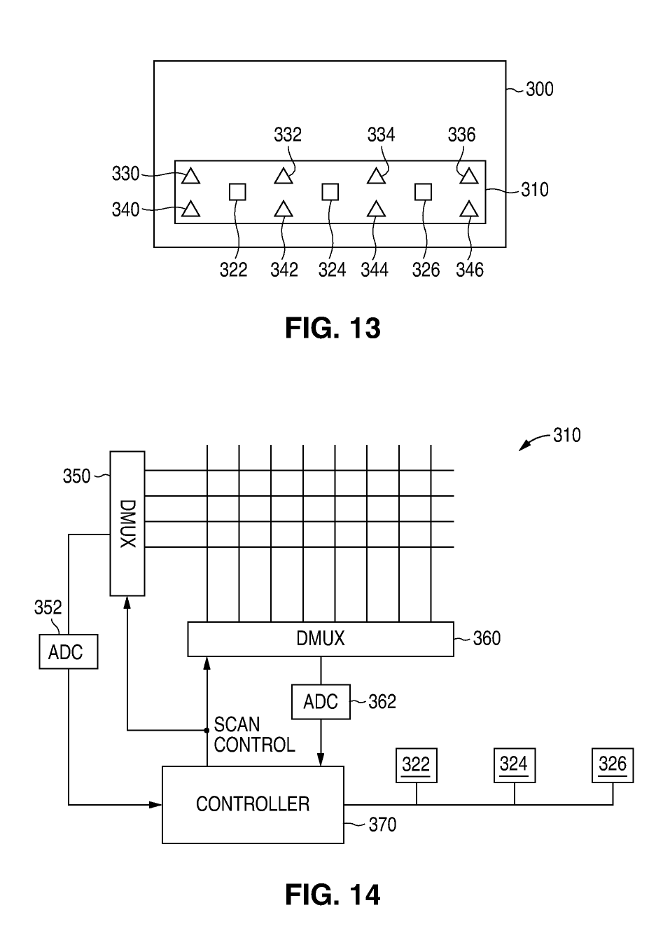

In one embodiment, controller 108 activates or scans touch input device 150 when it senses object 102 in the physical proximity of touch input device 150, as discussed further below with respect to FIG. 12. In another embodiment, controller 108 activates or scans a portion of touch input device 150 that corresponds to the approximate position of object 102, e.g. the portion of the touch input device close to the a user's finger that is object 102, as discussed below with respect to FIGS. 13-18. In yet another embodiment, controller 108 activates or scans a selected touch input device corresponding to the position of object 102, as discussed further below with respect to FIGS. 17-19. Controller 108, in this example, is configured to control touch input device 150, e.g. scan for touch input, and capture a user's touch input data as INPUT from touch input device 150, e.g. a digital value corresponding to capacitively detected touch input discussed further below with respect to FIG. 14. Controller 108 may also be configured to interpret a series of approximate positions to a corresponding gesture. The optical proximity and position detection of the present invention for selective activation or scanning of touch input devices may be applied to a wide variety of embodiments without departing from the scope of the present invention.

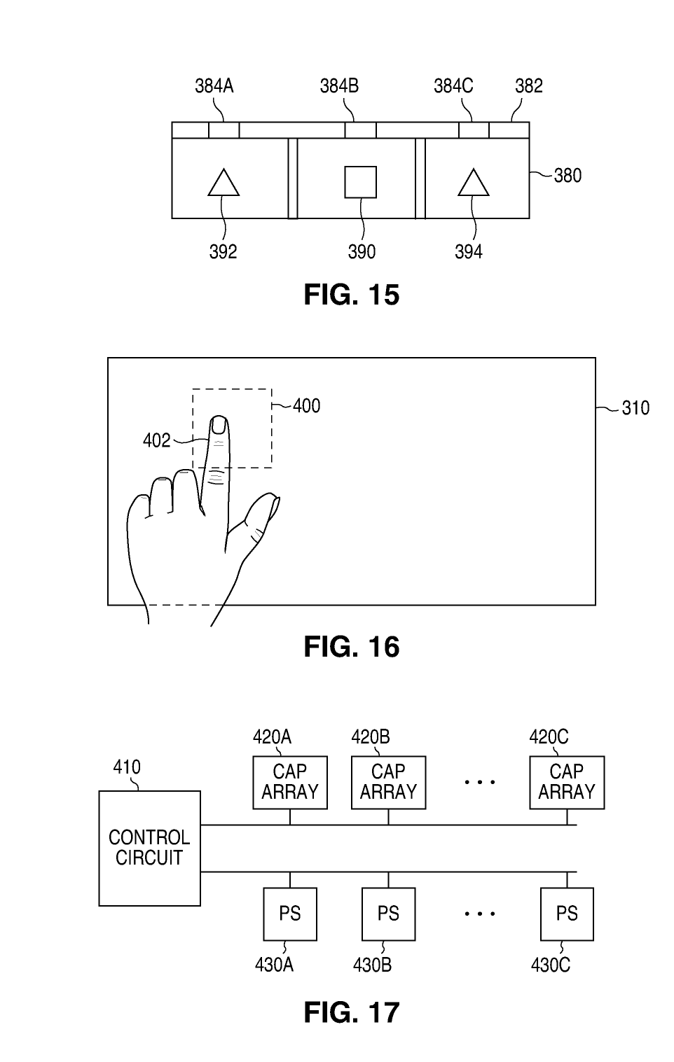

In one embodiment, optical isolation is provided, such as by a partition, to isolate photodiode 105 from receiving any crosstalk from LEDs 103A-C, as illustrated in FIG. 15. For example, one or more optical windows 384A-C may be provided in an opaque layer 382 disposed over a capacitive touch input device 380 to enable the desired light reflectance path from LEDs 392, 394 to photodiode receiver 390. Opaque barriers are preferably positioned between LEDs 392, 394 and photodiode receiver 390 to reduce crosstalk.

FIG. 11 is a circuit diagram illustrating one example of circuitry for optical reception 200 for a portion of the sensor circuit 100 of FIG. 10. Optical circuitry 200 may be implemented in a complimentary metal oxide semiconductor (CMOS) semiconductor process. Other circuitry logic may also be used to implement the optical receiving functionality without departing from the scope of the invention. The controller 108 may be external or integrated on the same chip substrate. Photodiode 105 can be external or integrated on the same chip. LEDs 103A-C are external in this example and generally physically positioned to permit controller 108 to determine an approximate position of an object 102 with respect to a touch input device 150, as noted with respect to FIG. 10.

Circuitry 200 includes DCACC 107 and ADC 111. The circuitry making up DCACC 107 is illustrated as enclosed by a broken perimeter labeled 107. DCACC 107 includes a trans-impedance amplifier (TIA) A1 (201), a transconductance amplifier (TCA) A2 (202), resistors R1 and R2, and a charge capacitor (C1). These components represent a low-cost and efficient implementation of DCACC 107.

DCA-0 switch (S2) 106 is illustrated as connected to a first PMOS gate (P2), which is in turn connected to a PMOS gate (P1). Gate P1 is connected inline with the output terminal of amplifier A2 (202). A2 receives its input from trans impedance amplifier A1 (201). For purposes of simplification in description, amplifier A2 will be referenced as TCA 202 and amplifier A1 will be referenced as TIA 201. TCA 202 removes DC and low frequency signals. It is important to note that for proximity sensing, TCA 202 takes its error input from the amplifier chain, more particularly from TIA 201. In this respect, TIA 201 includes amplifier A1 and resistor R1.

Controller 108 is not illustrated in FIG. 11, but is assumed to be present as an on board or as an off board component. Transmitting (TX) LEDs 103A-C are illustrated logically and not physically. An example of a physical layout for a three LED solution is illustrated in FIG. 8. LEDs 103A-C are positioned to permit an approximate position of an object 102 along, for example, X and Y axes relative to touch input device 150. One of ordinary skill in the art will readily understand implementations using two or more LEDs may be utilized and that multiple optical sensors and touch input devices may be combined as needed. In this example, LED TX control is provided by a connected controller as indicated by respective TX control lines.

When measuring reflectance, PD 105 receives reflected light from whichever LED 103A-C is activated by controller 108, where the reflected light is illustrated as a reflectance arrow emanating from object 102 and entering PD 105. The resulting current proceeds to TIA 201 formed by operational amplifier A1 and feedback resistor R1. Amplified output from TIA 201 proceeds through FBS 109 (S1) as signal VO (voltage out) to ADC 111.

Output from TIA 201 also proceeds through R2 to the input of DCACC 202 (A2). Here, the input is limited by a diode (D1) or an equivalent limiting circuit. In this way, the output of TCA 202 (A2) has a fixed maximum current to charge capacitance C1. This state causes the current proceeding through PMOS 204 (P1) to ramp at a maximum linear rate. At such time when the current through PMOS 201 (P1) equals the current produced by PD 105, the input error of TIA 201 goes to zero. This state causes the output of TIA to fall thereby reducing the error input to TCA 202 (A2). This slows and then prevents further charging of C1. DCACC 107 can only slew at a fixed rate for large signals and at a proportionally smaller rate for signals below the clipping level, the time it takes for DCACC 107 to correct the input signal change is a measure of the amplitude of the input signal change. In one embodiment, the reflectance value REFL output by ADC 111 is proportional to the total change of optical signal coupled into the photodiode generated by the LED. In other embodiments, the value REFL may be logarithmically compressed or inverted, for example, as required for the particular implementation.

In one embodiment, conversion of the input current to output pulse width includes converting both DC ambient and reflection signals to VO pulse width changes. DCA-0 switch 106 (S2) is closed during calibration and measurement of DC ambient light. Closing switch S2 causes the current through PMOS 204 (P1) to fall near zero while still maintaining voltage on C1 very close to the gate threshold of P1. A period of time is allowed for the DC ambient correction loop to settle. DAC-0 106 (S2) is opened after the correction loop has settled re-enabling the DC-ambient correction loop. The voltage at C1 then increases until the current through PMOS 204 (P1) equals the DC ambient photocurrent resulting from PD 105. Therefore, the time it takes for VO from amplifier A1 to return to its normal state after changing due to proximity detection is proportional to the DC-ambient input current output by PD 105 with the LEDs switched off.

Conversely, for measuring reflectance, S2 is held open while sufficient time is allowed for DC ambient background calibration including letting the DC ambient loop settle or cancel the average DC background ambient. After calibration is complete, TX LEDs 103A-C are enabled to transmit light. The subsequent increase in photocurrent put out by PD 105 as the result of reflectance from object 102 is amplified by A1 causing a change in VO output to ADC 111 only if the amplified change exceeds the proximity detection threshold set by Vref. After detecting reflectance (sensing proximity) the DC-ambient loop causes the voltage on C1 to increase until it cancels the increase in photocurrent due to reflectance. At this point in the process, VO (the amplified signal output from TIA 201) returns to its normal value, thus ending the detection cycle. The period of time between TX of the LEDs and when VO returns to its previous value is proportional to the magnitude of the reflectance signal.

One of skill in the art will recognize that within the sensor circuitry 200 presented in this example, DCACC 107 continuously operates to remove normal changes in the background ambient light. Only transient changes produce an output. Output only occurs when there is a difference between the DC correction signal and the input signal. An advantage of this method of reflectance measurement is that resolution is limited by the “shot noise” of PD 105, provided a low noise photo amplifier is used. Circuitry 200 exhibits low noise for the DC ambient correction current source if a moderately large PMOS is used for P1 and an appropriate degeneration resistor is used at its Vdd source. The integrator capacitor on the gate of P1 removes most of the noise components of TCA 202.

In this embodiment, feedback blanking is implemented by switch 109 (S1), which is driven by one-shot circuit (OS1) 110. OS1 110 produces a blanking pulse when the TX LED function is enabled, i.e. in response to the LED transmit control signals from the controller. This blanking pulse is wider in this example than the settling time for transients within TIA 201 (A1). As discussed further above, introducing a blanking pulse into the process increases the sensitivity of the receiver. Otherwise the sensitivity of the receiver is reduced due to feedback noise from the leading edge of the transmitted pulse from LEDs 103A-C.

FIG. 12 is a control flow diagram illustrating one example of a process 250 in the controller 108 of FIG. 10 that performs motion detection and touch screen activation suitable for use with the touch screen and optical proximity sensing systems shown in FIGS. 1-9. When process 250 is initiated in controller 108, motion detection begins, step 252, such as in the manner described above with respect to FIGS. 10-11. When the proximity of object 102 is detected at step 252, control proceeds to step 254 where controller 108 determines whether, in this embodiment, object 102 is approaching touch input device 150, which is interpreted by controller 108 as a gesture indicating, for example, a user's finger approaching the touch input device. If the object is not approaching, then control flows back to the start of the process to detect whether an object is within the proximity of the sensing system.

At step 260, controller 108 makes a determination of the approximate position of object 102 based on measured reflectance from multiple LEDs. If the approximate position of the object is near the touch input device, then control flow proceeds at step 262 to step 264, where the touch input device is activated. Otherwise, control branches to the beginning of process 250. In this embodiment, the touch input device remains inactive until activated by controller 108, at step 264, to receive touch input. This may be a power saving feature or may prevent spurious input at the touch input device. At step 266, controller 108 interacts with the touch input device that has been activated to capture the user's touch input. Optionally, controller 108 may continue to track the motion of object 102 to interpret a gesture. This option may be used to verify the user's touch input, e.g. confirm that a user's finger's double tap touch input to select, for example, an application for launch is consistent with the optically observed motion. By way of another example, a user's sliding motion, e.g. scrolling, may be interpreted both optically and by capacitive touch input detection. Note that some of the steps of process 250 may be omitted or combined or taken in different order without departing from the scope of the present invention and that other forms of processing may be utilized with the present invention as will be understood by one of skill in the art.

The present invention may be applied to systems where portions of a touch input device may be selectively activated or scanned. FIG. 13 is a top view of an example of a user input system 300 featuring a touch screen 310 and optical proximity sensing system having multiple proximity sensors where the touch screen 310 may be selectively activated or scanned. System 300 features multiple optical receivers 322, 324, 326 and transmit LEDs 330, 332, 334, 336, 340, 342, 344, 346. The optical receivers 322, 324, 326 may be multiple external photodiodes, such as photodiode 105 of FIG. 10, or may be receiver circuits integrated with a photodiode, where multiple sensor circuits, such as the sensor system of 100. Multiple sensor circuits 100 may be interconnected with the LEDs and one another or, alternatively, the architecture and circuitry of FIGS. 10 and 11 can be adapted to control the LEDs and the optical receivers in the system 300. Note that the touch input device 310 is illustrated as a relatively large device, where user input activity may be expected to be localized to a limited portion of the touch input surface.

FIG. 14 is a functional block diagram of one example of a touch screen 310 and optical proximity sensing system suitable for use with the user input system 300 of FIG. 13. Screen 310 includes a demultiplexor (DMUX) 350 for scanning cross points of a capacitive array of the screen 310 along a Y axis, in this example, while a second demultiplexor 360 scans along an X axis. DMUXs 350 and 360 are controlled by controller 370, which may be controller 108 of FIG. 10 or may be a processor dedicated to scanning the touch screen array. The SCAN CONTROL signal from controller 370 determines which of the X and Y lines of the touch screen array are scanned. When DMUX 350 scans a selected Y line of the touch screen array in response to the SCAN CONTROL signal, then the signal from the selected Y line is input to analog to digital converter 352, which transforms the scanned signal into a digital value that is output to controller 370 for further processing. For example, a frequency may be applied to the capacitive array that is shifted when a user touch closes a cross point on the array. The resulting frequency is converted to a digital value by ADC 352. DMUX 360 similarly scans the X lines of the touch screen array responsive to the SCAN CONTROL signal.

In the embodiment of FIG. 310, controller 370 is in communication with optical receivers 322, 324, 326. In one embodiment, the optical receivers 322, 324, 326 may each be similar to the sensor system 100 of FIG. 10 adapted to control the transmit LEDs and communicate the resulting reflectance measurements or position determinations to controller 370. In another embodiment, the architecture of FIG. 10 is adapted, for example, to have multiple external photodiodes 105 with corresponding optical receiving circuitry 101 under the control of controller 108 as controller 370. One of ordinary skill will recognize that a variety of circuits may be utilized to perform optical proximity sensing and position detection described herein without departing from the scope of the present invention.

When an object's position is determined by controller 370, the controller 370 may be configured to scan only the cross points of the capacitive array of touch screen 310 corresponding to the position of the object. In this manner, the present invention may be utilized to activate or scan only the portion of the touch screen 310 in the proximity of the object 102. This approach may be utilized to save power or avoid spurious input from other regions of the touch screen 310. Alternatively, SCAN CONTROL may be used to control the rate of scanning, where, for example, the region of the touch screen 310 in proximity to the object 102 is scanned at a higher rate that other regions of the touch screen.

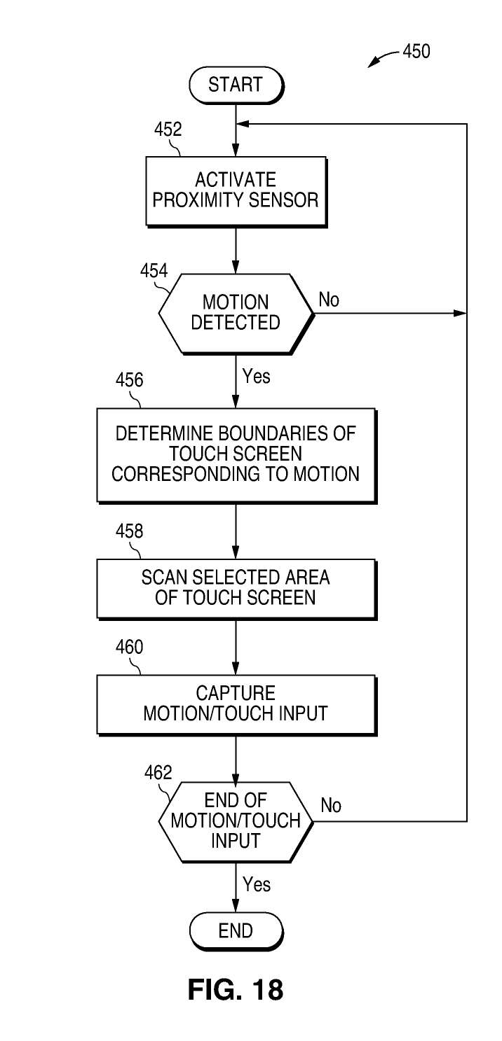

FIG. 16 is a simplified top view of the touch screen 310 and optical proximity sensing system of FIG. 13, where a portion 400 of the touch screen area is selectively activated or scanned as described above in response to the approach of a user's finger 402. In this example of the operation of the system of FIG. 13, the approach of the user's finger 402 is detected by, in this example, optical receiver 322 by measuring the light from LEDs reflected by the user's finger 402. Controller 370 determines the position of the finger 402 by triangulating the reflectance measurements, as described above, and scans the portion 400 of the touch screen 310 corresponding to the position of finger 402 in order to capture the user's touch screen input. By limiting the scan to the area 400 near where the motion of finger 402 is detected, for example, spurious input caused by the heel of the user's hand may be excluded. Alternatively, the scan rate for area 400 may be raised to increase the effective sensitivity or resolution of the touch screen input. This selective scanning or activation of a portion of a touch input screen is one variation of the process described with respect to the process 450 of FIG. 18.

FIG. 17 is a functional block diagram of another example of a touch screen and optical proximity sensing system where multiple proximity sensors 430A-C, similar to the sensor circuit shown in FIG. 10, are associated with multiple capacitive touch screen arrays or devices 420-C. Control circuit 410 may include a controller, such as controller 108, interfaced to multiple optical receiver circuits 101 and controlling multiple transmit LEDs, such as the configuration shown in FIG. 13. Alternatively, control circuit 410 may be a central processor that is interfaced to multiple sensor circuits similar to sensor circuit 100.

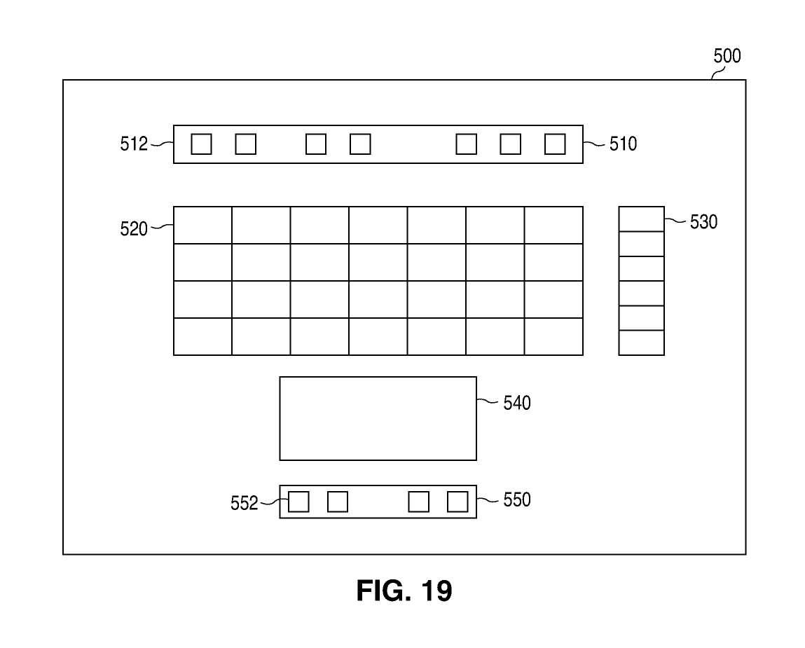

Control circuit 410 is also interfaced with multiple capacitive array devices 420A-C, such as touch screens, which may make up a larger single touch input device or different devices. FIG. 19 illustrates an example of an input system 500 that includes a variety of different types of touch input devices. In this example, touch screen 510 is configured to feature a series of areas corresponding to push buttons, such as button 512. Touch screen 520 is configured as a keyboard device. Touch screens 510 and 520 generally require relatively coarse touch input resolution. Touch screen 530 is configured as a slider input device that performs some gesture recognition, e.g. sliding downward or upward, and generally requires intermediate input resolution and may benefit from optical gesture recognition. Touch screen 540 is configured as a high resolution input device for fine touch input. Touch screen 550 is a finer resolution button input device. Using, for example, the architecture of FIG. 17, optical sensor circuits may be positioned in correlation with the touch screen devices and the controller configured to selectively enable one or more of the touch screen devices based on the position of a user's hand or finger. For example, fine resolution touch screen input device 540 may only be activated if user motion is detected in the proximity of touch screen 540. Likewise, touch screen 530 may be activated only when user activity is optically sensed in the proximity of the device and the user's slider input gesture may be sensed using the touch screen and verified by optical motion sensing. Similarly, touch screen 510 is activated when the motion of the user's finger is optically detected and a touch sensed push button input optically confirmed. This selective activation of devices is one variation of the process described with respect to the process 450 of FIG. 18.

FIG. 18 is a control flow diagram illustrating one example of a process 450 in, for example, the controller 108 of FIG. 10 or controller 370 of FIG. 14 that performs motion detection, selective touch screen activation or scanning, and gesture recognition based on approximating changes in position using reflectance measurements suitable for use with the touch screen and optical proximity sensing system shown in FIGS. 13 and 14 extending the principles of optical position detection described above with respect to FIGS. 1-9. When process 450 is initiated in controller 108, for example, motion detection begins, step 452, with activation of the optical proximity sensors such as in the manner described above with respect to FIGS. 10-11. At step 454, the optical detection circuits are used to search for an object in proximity, either continuously or at intervals. When the proximity of object 102 is detected at step 454, control proceeds to step 456 where controller 108 determines the position of object 102 and determines the boundaries of a portion of a touch screen corresponding to the position of the object, e.g. area 400 in FIG. 16, or, in the embodiment of FIG. 19, which touch screen device corresponds to the position of the object. The detection of motion helps limit user input to an area of current activity rather than an inactive input due, for example, to a user resting his hand on another portion of a touch screen device or another touch screen device without an intent to perform a touch input.

At step 458, the area of the touch screen, e.g. area 400, corresponding to the position of the object is selectively activated or scanned. For the embodiment of FIGS. 17 and 19, step 458 is modified to selectively activate the touch screen device corresponding to the position of the user's motion, e.g. touch screen 540. At step 460, the user touch input is captured by the controller from the selected touch screen area or selected touch screen device. As noted above, the optical motion may be interpreted to recognize the gesture in combination with the touch screen input to verify or augment the touch screen input. If further input is desired, e.g. confirmation of a push button or tap motion, then control branches back to step 452 for further input. Otherwise, the process ends, for example, until the next input scan cycle is performed. Note that some of the steps of process 450 may be omitted or combined or taken in different order without departing from the scope of the present invention and that one of skill in the art will understand that other forms of processing may be utilized with the present invention.

In order to determine motion in a controller of a system according to the present invention, for example, an approximate position P1 for an object is determined from reflectance measurement values REFL obtained at a first point in time, T1, using the optical sensor circuitry. An approximate position for the object is determined from reflectance measurement values REFL obtained using sensor 100 at a second point in time, T2. The approximate positions P1 and P2 are then compared in order to identify motion or a corresponding gesture. For example, the relative motion from P1 to P2 is determined and normalized to a value RELATIVE MOTION that may be used to index a look-up or symbol table to obtain a GESTURE ID value corresponding to a gesture corresponding to the motion vector from P1 to P2 or a value indicating that no gesture could be identified for the motion. Likewise, the normalized approximate positions may be utilized to index a look-up table to identify a touch screen device responsive to the user's motion or the normalized positions may be utilized to calculate the boundaries of a touch screen to be activated or scanned responsive to the user's motion.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A touch input and optical proximity sensing system, the system comprising:
first and second light sources;
a first optical receiver configured to receive a first reflected light signal from an object when the first light source is activated and output a first measured reflectance value corresponding to an amplitude of the first reflected light signal and receive a second reflected light signal from the object when the second light source is activated and output a second measured reflectance value corresponding to an amplitude of the second reflected light signal;
a first touch input device, where the first and second light sources and the first optical receiver are in predetermined positions relative to the first touch input device; and
a controller in communication and control of the first and second light sources, the first optical receiver and the first touch input device, where the controller is configured to independently activate the first and second light sources to produce the first and second reflected light signals and capture the first and second measured reflectance values from the first optical receiver, and the controller is further configured to determine a first approximate position of the object based on the first and second measured reflectance values and determine whether the first approximate position of the object is within a predetermined proximity area to the first touch input device and, if the object is within the predetermined proximity area, the controller is configured to activate at least a portion of the first touch input device.

2. The touch input and optical proximity sensing system of claim 1, wherein:
the first optical receiver is configured to receive a third reflected light signal from an object when the first light source is activated and output a third measured reflectance value corresponding to an amplitude of the third reflected light signal and receive a fourth reflected light signal from the object when the second light source is activated and output a fourth measured reflectance value corresponding to an amplitude of the fourth reflected light signal; and
the controller is configured to independently activate the first and second light sources to produce the third and fourth reflected light signals and capture the third and fourth measured reflectance values from the first optical receiver, and the controller is further configured to determine a second approximate position of the object based on the third and fourth measured reflectance values and compare the first and second approximate positions in order determine whether the object is approaching the first touch input device and, activate the portion of the first touch input device when the object is approaching the first touch input device.

3. The touch input and optical proximity sensing system of claim 2, wherein:
the controller is further configured to identify a gesture of the object based on the first and second approximate positions.

4. The touch input and optical proximity sensing system of claim 3, wherein:
the controller is further configured to capture user touch input from the first touch input device and determine whether the gesture of the object is consistent with the user touch input.

5. The touch input and optical proximity sensing system of claim 1, wherein:
the first touch input device is configured to have regions that can be selectively activated by the controller; and
the controller is configured to selectively activate the first portion of the first touch input device based on the first approximate position of the object.

6. The touch input and optical proximity sensing system of claim 5, wherein the controller is configured to selectively activate the portion of the first touch input device by selectively scanning the portion of the first touch input device.

7. The touch input and optical proximity sensing system of claim 5, wherein:
the system further includes a third light source;
the first optical receiver is configured to receive a fifth reflected light signal from the object when the third light source is activated and output a fifth measured reflectance value corresponding to an amplitude of the fifth reflected light signal; and
the controller is in communication and control of the third light source and is configured to independently activate the third light source to produce the fifth reflected light signal and capture the fifth measured reflectance value from the first optical receiver, and the controller is further configured to determine the first approximate position of the object based on the first, second and fifth measured reflectance values and selectively activate the portion of the first touch input device based on the first approximate position derived from the first, second and fifth measured reflectance values.

8. The touch input and optical proximity sensing system of claim 1, wherein:
the system includes a second touch input device; and
the controller is in communication and control of the second touch input device and is configured to selectively activate at least one of the first and second touch input devices based on the first approximate position of the object.

9. The touch input and optical proximity sensing system of claim 1, wherein the controller is configured to activate the portion of the first touch input device by scanning the portion of the first touch input device.

10. The touch input and optical proximity sensing system of claim 1, wherein the system further includes:
a second optical receiver mounted in a predetermined position with respect to the first and second light sources and the first input device and configured to receive reflected light signals from the object when at least one of the first and second light sources is activated and output a first measured reflectance value corresponding to an amplitude of the received reflected light signals; and
the controller is in communication and control of the first second optical receiver, where the controller is further configured to capture the measured reflectance values from the second optical receiver and determine the first approximate position of the object based on the first and second measured reflectance values and the measured reflectance values from the second optical receiver in order to determine whether the first approximate position of the object is within the predetermined proximity area to the first touch input device.

11. A method for optical proximity sensing and touch input control, the method comprising the steps of:
mounting a plurality of light sources and a first optical receiver in predetermined position relative to a first touch input device;
activating at least a first one of the light sources and measuring an amplitude of a first reflected light signal from an object using the first optical receiver to obtain a first measured reflectance value;
activating at least a second one of the light sources and measuring an amplitude of a second reflected light signal from the object using the first optical receiver to obtain a second measured reflectance value;
determining a first approximate position of the object based on the first and second measured reflectance values;
determining whether the first approximate position of the object is within a predetermined proximity area to the first touch input device; and
activating at least a portion of the first touch input device if the object is within the predetermined proximity area.

12. The method for optical proximity sensing and touch input control of claim 11, wherein the method includes the steps of:
activating the first one of the light sources and measuring an amplitude of a third reflected light signal from the object using the first optical receiver to obtain a third measured reflectance value;
activating the second one of the light sources and measuring an amplitude of a fourth reflected light signal from the object using the first optical receiver to obtain a fourth measured reflectance value;
determining a second approximate position of the object based on the third and fourth measured reflectance values; and
comparing the first and second approximate positions in order determine whether the object is approaching the first touch input device; and wherein:
the step of activating at least a portion of the first touch input device further includes activating the portion of the first touch input device when the object is approaching the first touch input device.

13. The method for optical proximity sensing and touch input control of claim 12, where the method includes the step of identifying a gesture of the object based on the first and second approximate positions.

14. The method for optical proximity sensing and touch input control of claim 13, where the method includes the steps of capturing user touch input from the first touch input device and determining whether the gesture of the object is consistent with the user touch input.

15. The method for optical proximity sensing and touch input control of claim 11, wherein the first touch input device is configured to have regions that can be selectively activated and the step of activating the portion of the first touch input device further comprises selectively activating the first portion of the first touch input device based on the first approximate position of the object.

16. The method for optical proximity sensing and touch input control of claim M5, wherein the step of selectively activating the portion of the first touch input device further comprises selectively scanning the portion of the first touch input device.

17. The method for optical proximity sensing and touch input control of claim 15, wherein:
the method includes the steps of activating a third one of the light sources and measuring an amplitude of a fifth reflected light signal from the object using the first optical receiver to obtain a fifth measured reflectance value;
the step of determining a first approximate position of the object further comprises determining the first approximate position of the object based on the first, second and fifth measured reflectance values; and
the step of selectively activating the portion of the first touch input device based on the first approximate position further includes selectively activating the portion of the first touch input device based on the first approximate position derived from the first, second and fifth measured reflectance values.

18. The method for optical proximity sensing and touch input control of claim 11, wherein:
the method includes mounting a second touch input device in predetermined position relative to the plurality of light sources and the first optical receiver; and
the step of determining whether the first approximate position of the object is within a predetermined proximity area to the first touch input device further includes determining whether the first approximate position of the object is within another predetermined proximity area to the second touch input device; and
the method includes the step of activating at least a portion of the second touch input device if the object is within the another predetermined proximity area.

19. The method for optical proximity sensing and touch input control of claim 11, wherein the step of activating at least a portion of the first touch input device further comprises scanning the portion of the first touch input device.

20. The method for optical proximity sensing and touch input control of claim 11, wherein:
the method includes mounting a second optical receiver in a predetermined position with respect to the first and second light sources and the first touch input device, where the second optical receiver is configured to receive reflected light signals from the object when at least one of the first and second light sources is activated and output a first measured reflectance value corresponding to an amplitude of the received reflected light signals; and
the step of determining the first approximate position of the object further comprises determining the first approximate position of the object based on the first and second measured reflectance values and the measured reflectance values from the second optical receiver in order to determine whether the first approximate position of the object is within the predetermined proximity area to the first touch input device.

21. An optical proximity sensing and touch input control system, the system comprising:
a plurality of light sources and at least one optical receiver mounted in predetermined position relative to at least one touch input device;
means for activating at least a first one of the light sources and measuring an amplitude of a first reflected light signal from an object using at least one optical receiver to obtain a first measured reflectance value;
means for activating at least a second one of the light sources and measuring an amplitude of a second reflected light signal from the object using at least one optical receiver to obtain a second measured reflectance value;
means for determining a first approximate position of the object based on the first and second measured reflectance values;
means for determining whether the first approximate position of the object is within a predetermined proximity area to at least one touch input device; and
means for activating at least a portion of at least one touch input device if the object is within the predetermined proximity area.
